(19) United States
(12) Patent Application Publication
(10) Pub. No.: US 2006/0138308 A1
(43) Pub. Date: Jun. 29, 2006

(54) Vehicle entertainment system utilitzing portable media player

(76) Inventors: J. Roger Davis, Russiaville, IN (US); Douglas L. Welk, Rossville, IN (US)

Correspondence Address: DELPHI TECHNOLOGIES, INC., M/C 480-410-202, PO BOX 5052, TROY, MI, 48007, US

(21) Appl. No.: 11/253,970

(22) Filed: Oct. 19, 2005

Related U.S. Application Data
(60) Provisional application No. 60/639,940, filed on Dec. 29, 2004.

(51) Int. Cl. H01J 40/14

(52) U.S. Cl. 250/215

(57) ABSTRACT

The present invention provides an entertainment system including a control unit including at least one processor, and at least one portable device adapted to connect to the control unit and to store content, the at least one processor configured to detect the connection of the at least one portable device to the control unit and to automatically locate stored content upon detection of the at least one portable device.

### TECHNICAL BACKGROUND

The present invention generally relates to vehicle rear-seat entertainment systems and more particularly relates to the presentation of video content in such systems.

### BACKGROUND OF THE INVENTION

Today's rear-seat entertainment systems are typically capable of providing entertainment from one or more of the following sources: video cassette tape, digital video disc (“DVD”), television receiver, or auxiliary input (e.g., video game system console, portable DVD player, etc.). While these sources have been sufficient to date, they do not adequately support the presentation of video content that has been delivered via the Internet from newer digital video services or legally recorded with a set-top box. Some services, such as Starz! Ticket™ and MovieLink® allow a subscriber to log into a content portal and download selected movies, music videos and television programs to a personal computer. Additionally, some content providers provide set-top boxes capable of recording content legally.

A number of portable content players are available that allow downloaded video content to be viewed in a mobile environment independent of a rear-seat entertainment system. However, these devices are expensive and have small viewing screens (i.e., 7.62 cm to 10.16 cm), which reduce their utility. Portable MP3 players are also available for use in a mobile environment, but these devices are only capable of playing back audio content.

### SUMMARY OF THE INVENTION

The present invention provides a mechanism to allow portable content storage devices to be used to playback video data, audio data, audio visual data and/or photo data in a mobile environment. In one form of the present invention an entertainment system includes a control unit including at least one processor, and at least one portable device adapted to connect to the control unit and to store content, the at least one processor configured to detect the connection of the at least one portable device to the control unit and to automatically locate stored content upon detection of the at least one portable device.

In another form of the present invention an entertainment system includes a control unit, an auxiliary device connected to the control unit and including at least one processor, and at least one portable device connected to the auxiliary device adapted to store content. The at least one processor is configured to detect the connection of the at least one portable device to the auxiliary device and to automatically locate stored content upon detection of the at least one portable device.

In yet another form of the present invention, a control unit includes at least one processor and a receiver, and at least one portable device is coupled to the control unit and includes a transmitter. The at least one portable device is adapted to store content and to communicate with the control unit over a wireless communication link established between the transmitter and the receiver, and the at least one processor is configured to detect the communication link and to automatically locate stored content upon detection of the communication link.

In still another form, the present invention includes a rear-seat control unit, an auxiliary device connected to the rear-seat control unit and including at least one processor and a receiver, and at least one portable device coupled to the auxiliary device and having a transmitter, the at least one portable device adapted to store content and to communicate with the auxiliary device over a wireless communication link established between the transmitter and the receiver, the at least one processor configured to detect the communication link and to automatically locate stored content upon detection of the communication link.

### BRIEF DESCRIPTION OF THE DRAWINGS

The above-mentioned and other features of this invention, and the manner of attaining them, will become more apparent and the invention itself will be better understood by reference to the following description of embodiments of the invention taken in conjunction with the accompanying drawings, wherein:

FIG. 1A illustrates an example of how the portable hard drive of the present invention receives content;

FIG. 1B illustrates another example of how the portable hard drive of the present invention receives content;

FIG. 1C illustrates yet another example of how the portable hard drive of the present invention receives content;

FIG. 2 is a perspective view of a prior art vehicle entertainment system;

FIG. 3 is a perspective view of an embodiment of the vehicle entertainment system of the present invention;

FIG. 4 is a perspective view of another embodiment of the vehicle entertainment system of the present invention;

FIG. 5 is a perspective view of another embodiment of the vehicle entertainment system of the present invention; and

FIG. 6 is a perspective view of another embodiment of the vehicle entertainment system of the present invention.

Corresponding reference characters indicate corresponding parts throughout the several views. Although the drawings represent embodiments of the present invention, the drawings are not necessarily to scale and certain features may be exaggerated in order to better illustrate and explain the present invention.

### DESCRIPTION OF THE PRESENT INVENTION

The embodiments disclosed below are not intended to be exhaustive or limit the invention to the precise forms disclosed in the following detailed description. Rather, the embodiments are chosen and described so that others skilled in the art may utilize their teachings.

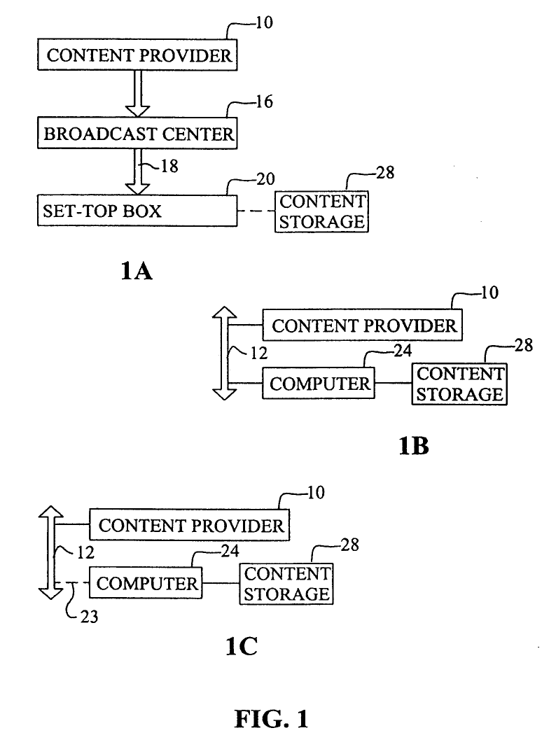

For purposes of the present invention, “content” is hereinafter described as audio data, video data, photo data (e.g., photographs and still video images) and/or audio visual data. Content is stored in the memory of a storage device, which in the exemplary embodiment includes a portable hard drive. However, other types of memory storage devices, volatile and non-volatile, may alternatively be used, such as memory sticks, optical disks, etc. Portable hard drive players are used to play content stored on portable hard drives. A portable hard drive player appears as a removable hard drive on a personal computer and as a valid storage device for set-top boxes used to receive and record video content from a content provider. Illustrative examples of how portable hard drives receive content are shown in FIGS. 1A and 1B.

In FIG. 1A, content provider 10 provides content to broadcast center 16 via satellite, fiber optic cable or digital tape. Broadcast center 16 then broadcasts the content to set-top box 20 over communication channel 18. Communication channel 18 may include a telephone wire, a digital satellite broadcast, a terrestrial broadcast or a cable television channel (i.e., cable). Set-top box 20 operates as a computer that receives and decodes analog and digital broadcasts. Set-top box 20 includes hard drive 28, which enables set-top box 20 to record content received from content provider 10 as long as hard drive 28 supports an appropriate level of digital rights management.

In FIG. 1B, content provider 10 makes content available on a web site, and a user of computer 24 downloads the content over a global communication network, e.g., Internet 12. Hard drive 28 is connected to computer 24 and is used to store the content. The content may be copied to hard drive 28 using a file management program on computer 24 such as Windows Explorer™ or media management programs such as Windows Media Player™, Real Jukebox™ or MusicMatch™. Alternatively, as shown in FIG. 1C, portable computer 24 with a wireless connection 23 to Internet 12 may be used to download content while in the mobile environment.

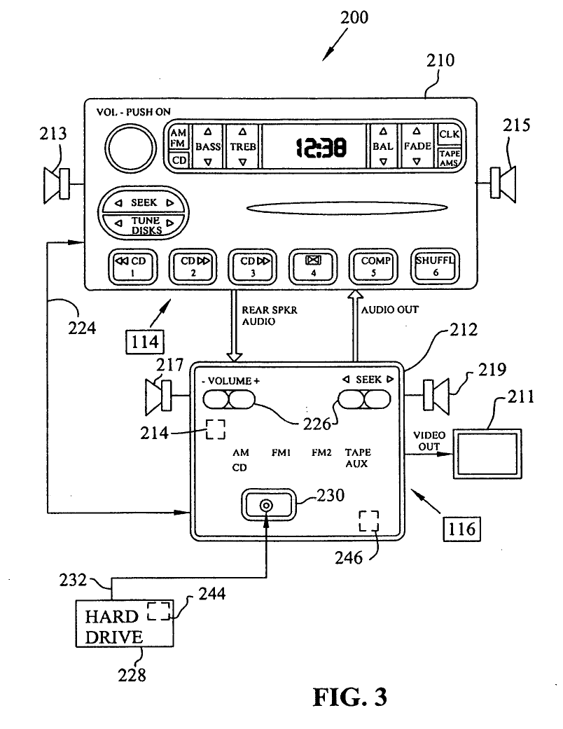

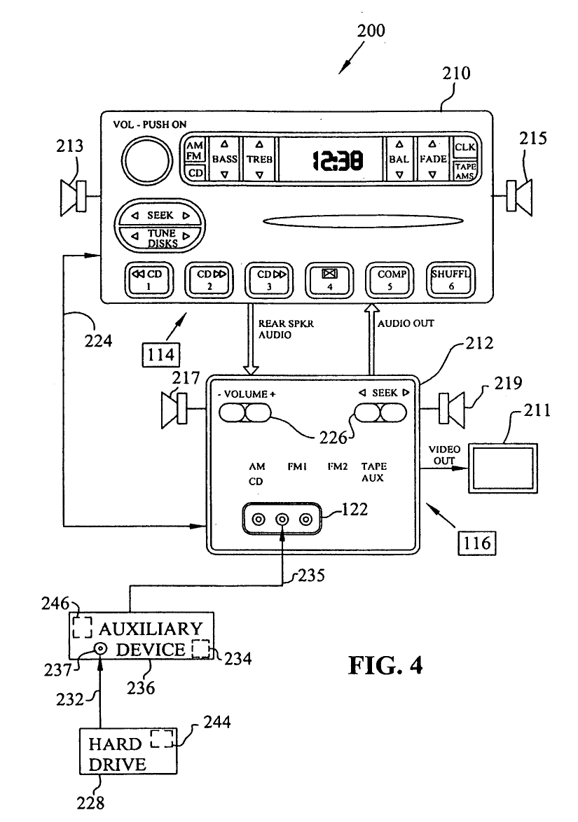

In FIGS. 1A, 1B and 1C, hard drive 28 may be integrated with set-top box 20 and computer 24, respectively, but in an exemplary embodiment of the present invention, hard drive 28 is portable and embodied in a portable content player, e.g., Apple Inc.'s iPOD® (is a registered trademark of Apple Computer, Inc. of Cupertino, Calif.). Accordingly, portable hard drive 228 (FIGS. 3 and 4) is connected to set-top box 20/computer 24 and used to move content between set-top box 20/computer 24 and other computers, much as can be done with floppy disks, multimedia cards, or universal serial bus flash memory devices.

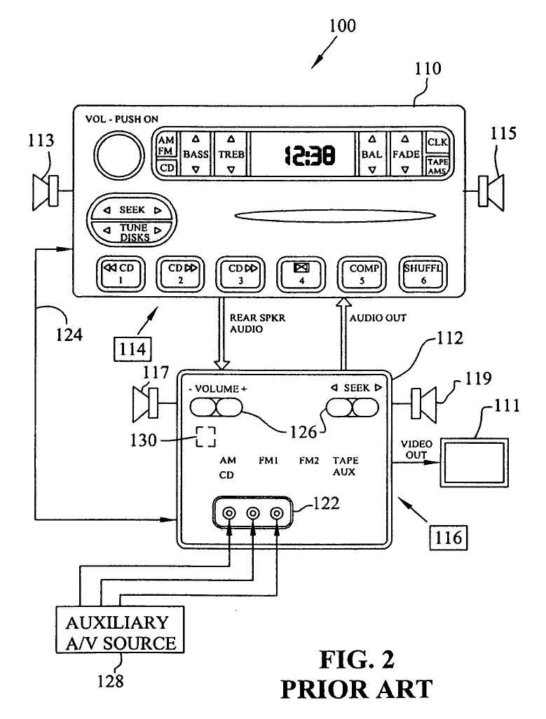

The use of portable hard drive 228 enables content stored therein to be viewed in a mobile environment, such as in a vehicle. FIG. 2 shows a prior art vehicle entertainment system 100 for use in a vehicle. Vehicle entertainment system 100 includes front control unit 110 and a remote control unit 112. Front control unit 110 is mounted for use by a user in front seat area 114 of the vehicle, and remote control unit 112 may be mounted anywhere in the vehicle. Front seat area 114 refers to the area in the vehicle in which a front seat passenger is able to comfortably and readily manipulate the controls of front control unit 110. Rear seat area 116 includes any area in a vehicle in which a rear seat passenger is able to manipulate the controls of remote control unit 112.

The provision of front control unit 110 enables a vehicle to be produced either with or without the audio and video functions of remote control unit 112. Left front vehicle speaker 113 and right front vehicle speaker 115 are connected to front control unit 110. Front control unit 110 is in communication with remote control unit 112 via network 142, e.g., a J1850 or a controller area network.

Remote control unit 112 is provided to enhance the entertainment experience of a vehicle's passengers. For example, if remote control unit 112 is positioned in rear seat area 116 of the vehicle, remote control unit enhances the entertainment experience of a vehicle's rear-seat passengers. Remote control unit 112 includes one or more microprocessors 130, volume and seek controls 126, and connector port 122 for connecting to auxiliary audio/video source 128, such as a video game player, a portable DVD player or a camcorder. Connected to remote control unit 112 are left rear speaker 117, right rear speaker 119 and video screen 111.

One embodiment of the vehicle entertainment system of the present invention is shown in FIG. 3. Similar to the system shown in FIG. 2, vehicle entertainment system 200 includes front control unit 210 and remote control unit 212. In an exemplary embodiment of the present invention, remote control unit 212 is a rear-seat control unit. A “rear-seat control unit” is herein defined as a control unit designed to fit in the rear seat area of the vehicle. A rear-seat control unit may be smaller in dimension (i.e. height, width and length) than front control unit 110 so that it fits within rear seat area 116 of the vehicle. For example, rear seat area 116 may include remote control unit 112 positioned between the front driver and front passenger seats, control unit 112 positioned between the rear passenger seats and/or control unit 112 mounted in the ceiling of the vehicle.

Remote control unit 212 includes one or more microprocessors 214 and communicates with front control unit 210 over communication network 224. Remote control unit 212 includes volume and seek controls 226 as well as connector port 230. Rear speakers 217, 219 are coupled to remote control unit 212 and enables control unit 212 to present the stored audio data to the vehicle's passengers. Similarly, video monitor 211 is coupled to remote control unit 212 and enables stored video data to be presented to the vehicle's passengers.

Connector port 230 is adapted to enable portable hard drive 228 to connect to remote control unit 212 through communication interface 232. In an exemplary embodiment of the present invention, communication interface 232 is a cable utilizing one of an universal serial bus, a FireWire® (FIREWIRE is a registered trademark of Apple Computer, Inc. of Cupertino, Calif.), an IEEE 1394, an i.Link® (I.LINK is a registered trademark of Sony Corporation of Tokyo, Japan), or any other communication standard suitable for transferring content. Multiple connector ports 230 may be provided to enable multiple portable hard drives 228 and/or other portable electronic devices to connect to remote control unit 212.

In other embodiments of system 200, portable hard drive 228 may communicate with remote control unit 212 using a short range wireless radio-frequency (“RF”) technology. The most notable of these technologies include 802.11, Bluetooth and Home RF. If such a wireless technology is used, hard drive 228 may include a RF transmitter 244 and hardware configured to transmit content, and remote control unit 212 may include a receiver 246 and hardware configured to receive the transmitted content.

In accordance with system 200 of FIG. 3, once content is stored to portable hard drive 228, hard drive 228 may be taken to a vehicle and plugged into connector port 230. In an exemplary embodiment of the present invention, microprocessor 214 of remote control unit 212 is programmed to detect that portable hard drive 228 has been connected to remote control unit 212. In other embodiments of the present invention, microprocessor 214 is programmed to detect whether a RF communication link has been established between portable hard drive 228 and remote control unit 212. In still other embodiments of the present invention, microprocessor 214 is programmed to detect both a physically connected portable hard drive 228 and a RF-connected hard drive 228. If multiple hard drives 228 and/or other portable electronic devices have been connected to remote control unit 212 either by communication interface 232 or by RF communication link, microprocessor 214 detects the connection of each hard drive 228 and/or electronic device.

Microprocessor 214 is also programmed to scan one or more hard drives 228 and/or other electronic devices connected to remote control unit 212 to locate content. Multiple processors may be used to carry out this function. For example, a first microprocessor may be programmed to locate audio data files stored in the WAVE, MP3 or other known audio formats. A second microprocessor may be used to locate audio visual data files stored in the Audio Video Interleave or other known audio visual formats. A third microprocessor may be used to locate video data files stored in the MPEG-2, Motion JPEG and other known video formats, and a fourth microprocessor may be used to locate and decode photo data files stored in the JPEG and other known image formats. In other embodiments of the present invention, microprocessor 214 is programmed to locate content stored in predetermined locations on portable hard drive 228, for example, in a specified “audio” or “video” content files.

Microprocessor 214 is further programmed to check appropriate rights management authorizations and to retrieve, decode and present the located content to the user of remote control unit 212 via speakers 213, 215, 217, 219 and/or video screen 211.

Another embodiment of the present invention is shown in FIG. 4. In this rear-seat entertainment system 200, remote control unit 212 includes audio/video inputs 122, e.g., RCA jacks. Auxiliary connector 235, e.g., a RCA cord, connects auxiliary device 236 to audio/video inputs 122. Auxiliary device 236 includes one or more microprocessors 234 and one or more connector ports 237. In an exemplary embodiment of the present invention, portable hard drive 228 connects to auxiliary device 236 via communication interface 232 and connector port 237. In other embodiments of the present invention, hard drive 228 may include RF transmitter 244 and hardware configured to wirelessly transmit content, and auxiliary device may include receiver 246 and hardware configured to receive the transmitted content.

When one or more hard drives 228 and/or other electronic devices are connected to auxiliary device 236, microprocessor 234 is programmed to recognize that hard drives 228 have been connected and to scan hard drives 228 for content stored in the format(s) that microprocessor 234 is programmed to decode. In other embodiments of the present invention, microprocessor 234 is programmed to detect whether a RF communication link has been established between portable hard drive 228 and auxiliary device 236. Once microprocessor 234 locates the content, microprocessor 234 checks appropriate rights management authorizations and retrieves, decodes and presents the content for presentation to the end user by way of speakers 213, 215, 217, 219 and/or video screen 211.

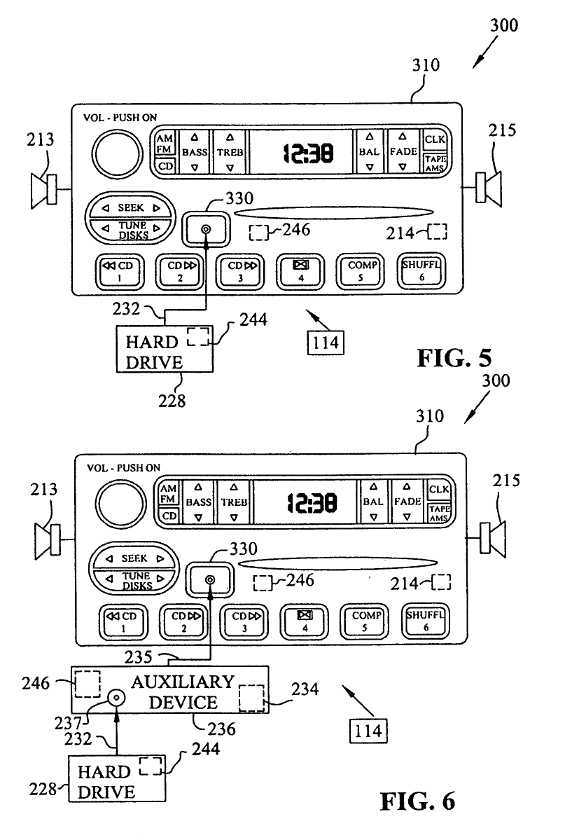

In other embodiments of the present invention, hard drive 228 may connected to front control unit 310 positioned in front seat area 114 of the vehicle (FIG. 5), or to auxiliary device 237 (FIG. 6) coupled to front control unit 310. In both instances, hard drive 228 operates with front control unit 310 in the same way as hard drive 228 has been described herein as operating with remote control unit 212.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

We claim:

1. An entertainment system comprising:
a control unit including at least one processor; and
at least one portable device adapted to connect to said control unit and to store content, said at least one processor configured to detect the connection of said at least one portable device to said control unit and to automatically locate stored content upon detection of said at least one portable device.

2. The entertainment system of claim 1 wherein said at least one processor is configured to decode the stored content.

3. The entertainment system of claim 1 wherein said at least one portable device is configured to store content including audio data.

4. The entertainment system of claim 1 wherein said at least one portable device is configured to store content including video data.

5. The entertainment system of claim 1 where said at least one portable device is configured to store content including photo data.

6. The entertainment system of claim 1 wherein said control unit is configured to mount in one of the front seat area and the rear seat area of a vehicle.

7. An entertainment system comprising:
a control unit;
an auxiliary device connected to said control unit and including at least one processor; and
at least one portable device connected to said auxiliary device and adapted to store content, said at least one processor configured to detect the connection of said at least one portable device to said auxiliary device and to automatically locate stored content upon detection of said at least one portable device.

8. The entertainment system of claim 7 wherein said at least one portable device is configured to store content that includes audio data.

9. The entertainment system of claim 7 wherein said at least one portable device is configured to store content that includes video data.

10. The entertainment system of claim 7 wherein said at least one portable device is configured to store content that includes photo data.

11. The entertainment system of claim 7 wherein said control unit is configured to mount in one of the front seat area and the rear seat area of a vehicle.

12. The entertainment system of claim 7 wherein said at least one processor is configured to decode the content.

13. An entertainment system comprising:
a control unit including at least one processor and a receiver; and
at least one portable device coupled to said control unit and including a transmitter, said at least one portable device adapted to store content and to communicate with said control unit over a wireless communication link established between said transmitter and said receiver, said at least one processor configured to detect the communication link and to automatically locate stored content upon detection of the communication link.

14. The entertainment system of claim 13 wherein said at least one processor is configured to decode the content.

15. The entertainment system of claim 13 wherein said at least one portable device is configured to store content that includes audio data.

16. The entertainment system of claim 13 wherein said at least one portable device is configured to store content that includes video data.

17. An entertainment system comprising:
a rear-seat control unit;
an auxiliary device connected to said rear-seat control unit and including at least one processor and a receiver; and
at least one portable device coupled to said auxiliary device and having a transmitter, said at least one portable device adapted to store content and to communicate with said auxiliary device over a wireless communication link established between said transmitter and said receiver, said at least one processor configured to detect the communication link and to automatically locate stored content upon detection of the communication link.

18. The entertainment system of claim 17 wherein said at least one processor is configured to decode the content.

19. The entertainment system of claim 17 wherein said at least one portable device is configured to store content that includes audio data.

20. The entertainment system of claim 17 wherein said at least one portable device is configured to store content that includes video data.
